(19) United States
(12) Patent Application Publication
(10) Pub. No.: US 2004/0086616 A1
(43) Pub. Date: May 6, 2004

(54) Extrusion processed starch-based, long lasting dog chew product

(75) Inventors: Li Nie, Kansas City, MO (US); Sukh Bassi, Atchison, KS (US); Clodualdo C. Maningat, Platte City, MO (US); Norman Worthy, Atchison, KS (US)

Correspondence Address: HOVEY WILLIAMS LLP, 2405 GRAND BLVD., SUITE 400, KANSAS CITY, MO, 64108, US

(73) Assignee: MGP INGREDIENTS, INC.

(21) Appl. No.: 10/284,553

(22) Filed: Oct. 30, 2002

(51) Int. Cl. A21D 10/00

(52) U.S. Cl. 426/549

(57) ABSTRACT

Starch-based extruded products are provided which are suitable as long-lasting dog chews. The products comprise quantities of starch, plasticizer, water and less than about 3% by weight fat. Preferably the starch comprises gelatinized starch which is capable of physical crosslinking or retrogradation. Preferably, a twin screw extrusion system including a preconditioner is used for production of the chews. Extrusion conditions are established so as to ensure adequate moisture content for retrograding of the gelatinized starch after processing.

### BACKGROUND OF THE INVENTION

1. Field of the Invention

The present invention is broadly concerned with starch-based extruded products especially suitable for use as long-lasting dog chews. More particularly, the invention is concerned with such extruded products and extrusion methods useful in forming the products.

2. Description of the Prior Art

The prior art is replete with different types of processed pet foods. For example, extruded dog foods have been a staple for many years, and a bewildering number of recipes and preparation methods have been disclosed. In physical forms, extruded dog foods have included moist, semi-moist and dried kibble-type feeds.

U.S. Pat. No. 4,284,652 discloses producing a matrix from which is formed a soft, dry pet food product. The matrix comprises starch, fat, polyhydric alcohol and water and results in a soft, pliable, and stretchable composition. The final pet food product will likely include amounts of protein and other nutritional ingredients. However, because of its soft, pliable nature, the product is intended for immediate consumption and is not suitable for forming a long-lasting dog chew.

Notwithstanding the existence of voluminous prior art in the pet food area, there is a notable lack of any references dealing with or describing long-lasting dog chew products. Furthermore, typical extruded dog feeds are designed for immediate consumption by an animal, rather than over an extended period.

Rawhide and pig ear products are commonly known in the art and provide desirable dog chewing properties. However, these products can cause concern over indigestion should the dog swallow a large portion of the chew.

Within the prior art there exists a number of starch based injection molded chew products having various shapes and designs. These products are generally brittle and tend to become slimy when contacted with water. Furthermore, these starch based products tend to dissolve in the dog's saliva thereby presenting a staining problem should the dog consume the chew indoors in the vicinity of carpet and upholstery.

Protein based injection molded products, particularly wheat gluten based products, exhibit several desirable chew treat properties. Protein based dog chews can be made ductile with proper packaging, are non-staining, are non-greasy and do not exhibit microbial concerns. However, protein based products do not exhibit as long a chew time as is generally desired and are more expensive to produce because of the protein content and production process employed.

### SUMMARY OF THE INVENTION

The present invention overcomes the above problems by providing an extruded, self-sustaining body which is suitable for forming a long-lasting dog chew and methods of preparing the same.

A body produced in accordance with the invention comprises respective quantities of starch, plasticizer and water. Furthermore, the body has low fat content, less than about 3% by weight, and preferably less than about 2% by weight.

Bodies produced according to the invention comprise between about 50-80% by weight starch, preferably between about 55-75% by weight, and more preferably between about 60-70% by weight. It is preferable for the starch to comprise a quantity of gelatinized starch, and more preferably the starch comprises almost entirely gelatinized starch. It is preferable that the gelatinized starch be selected from the group consisting of gelatinized wheat starch, corn starch, rice starch, tapioca starch, potato starch, and mixtures thereof. The starch selected should exhibit a retrograding capability. Waxy corn or other chemically modified or derived starches are not desirable due to low retrograding capability. Gelatinized starch is typically produced though a drum drying process which assures at least 95-100% gelatinization. A particularly preferred starch is a gelatinized wheat starch, Midsol Pregel-10, available from Midwest Grain Products, Inc., Atchison, Kans. The use of gelatinized starch, combined with proper formulation and processing conditions, enables the product to be extruded under temperatures less than about 120° C. so that expansion of the final product upon extrusion can be avoided. Expansion is to be avoided in order to obtain a specific, defined shape. The use of pregelatinized starch with the present invention is important to impart desirable properties to the final product and for efficient processing.

Preferred dog chew bodies comprise between about 15-23% by weight plasticizer, more preferably between about 16-22% by weight, and most preferably between about 17-21% by weight. It is preferable for the plasticizer to be selected from the group consisting of glycerin, propylene glycol, and mixtures thereof, with glycerin being most preferred. In the past, humectants such as sorbitol, manitol, sugar, and reducing sugars have been employed in dog chew formulations for helping the product to maintain moisture. However, in the context of the present invention, the use of such humectants is undesirable. The amount of plasticizer in the formulation is chosen so that the product body stays ductile at about 35% relative humidity and above. The plasticizer also helps control the water activity of the product to prevent microbial activity. Preferably, the product has a water activity of less than about 0.7.

Preferred dog chew bodies further comprise between about 6-15% by weight water, more preferably between about 7-14% by weight, and most preferably between about 8-13% by weight. As will be discussed in greater detail below, water performs several important functions in the overall formation of the final product.

Preferred embodiments according to the invention comprise less than about 10% by weight of palatability enhancer. Palatability enhancers are used in numerous pet food products to attract the animal to the food item. The palatability enhancer is preferably selected from the group consisting of meat and poultry broth concentrate or spray-dried powder, liver and liver digest broth concentrate or powder, hydrolyzed proteins, yeast extract, and distillery dry feed. Particularly preferred palatability enhancers are those derived from a liver source.

Additional preferred embodiments comprise one or more additional ingredients selected from the group consisting of coloring agents, flavoring agents, dental cleaning agents, and breath fresheners. It is preferable that such additional ingredients individually comprise less than about 3% by weight of the final product.

As noted above, dog chew bodies produced in accordance with the invention comprise less than about 3% and preferably, less than about 2% fat. The presence of commonly used lubricants such as edible vegetable oils, animal fat, glycerol mono-stearate, calcium mono-stearate, lecithin and its derivatives, fatty acids and fatty acid derivatives leads to weak chew products thereby reducing the chew life of the treats. These lubricants also tend to cause the products into which they are incorporated to feel slimy to the touch when contacted with water.

Methods of forming extruded, self-sustaining bodies according to the invention comprise providing a mixture of ingredients as described above and extruding the mixture. Preferred methods also include the step of preconditioning the mixture prior to extrusion thereof and the step of cooling the extruded body to room temperature after extrusion thereof.

In preferred methods, a powder mixture comprising a quantity of pre-gelatinized starch and between about 15-30 parts by weight plasticizer is provided. The powder mixture preferably contains at least about 90% by weight pre-gelatinized starch. Between about 10-20 parts by weight water is added to said mixture for every 100 parts by weight of powder mixture. The combined mixture is then extruded to form an extruded body. Preferably, the mixture has a temperature of less than about 115° C. at the extruder die.

In more detail, the dry starch component is added to the preconditioner and mixed with quantities of plasticizer and water. A particularly preferred preconditioner is a Wenger DDC model of the type shown in U.S. Pat. Nos. 4,752,139 and 5,161,888, incorporated by reference herein. Preferably, the total amount of water added during the extrusion process is between about 10-20% by weight, and more preferably between about 12-18% by weight based on the weight of the powder mixture in the feed being 100%.

While any type of extrusion apparatus is suitable for use with the invention, it is preferable to use a twin screw extruder of the type illustrated in U.S. Pat. No. 4,875,847, incorporated by reference herein; a family of such twin screw extruders is commercialized by Wenger Manufacturing, Inc. of Sabetha, Kans. under the designation “TX”. Preferably the mixture is then passed through one or more insert dies thereby forming extrudate strands. The die(s) may be configured so as to produce an extrudate strand having a particular cross-sectional profile, with exemplary profiles being rectangular, circular, and club-shaped. The strand thickness is specially chosen depending upon the size of dog ultimately intended to consume the chew product. Preferably the extrudate strand has a thickness of about ¼ to 1½ inches and more preferably from about ⅜ to 1 inch. The extrudate is placed on a conveying belt, cut at the end of the belt, and transferred to a cooler for cooling to room temperature. After exiting the cooler, the products can be packaged in canisters, ziplok bags or pouches, or hot melt sealed bags, for example.

Proper packaging is important to the quality control of products produced according to the invention. Because the preferred plasticizers for use in the invention have limited abilities to hold in moisture, especially in low relative humidity environments, it is important that the packaging material act as a good barrier to prevent the product from losing too much moisture too quickly during storage thereby causing the product to become brittle, especially in environments having a relative humidity of less than about 35%. Ifmoisture is allowed to escape slowly, over a prolonged period of time, the gelatinized starch molecules undergo physical crosslinking, or retrogradation. This crosslinking provides added hardness and strength to the final product thereby giving the dog chew a longer chew time and other desirable properties such as low swelling and non-slimy feel. It is preferable that such chew time be on the order of about 10-25 minutes. The greatest amount of starch crosslinking occurs within the first three weeks of manufacture. Therefore, proper packaging is required to assure sufficient moisture content within the product for at least three weeks. Any packaging material with good moisture barrier properties can be used as packaging materials, i.e., aluminum-plastic film laminates, PET, PVC, polystyrene, polypropylene thermoforms, PVP based laminates, polyethylene, and polypropylene films.

### DETAILED DESCRIPTION OF THE PREFERRED EMBODIMENT

The following examples set forth preferred extruded, self-sustaining bodies of the invention and preferred methods of forming the same. It is to be understood, however, that these examples are provided by way of illustration and nothing therein should be taken as a limitation upon the overall scope of the invention.

### EXAMPLE 1

In this example, three preferred dog chews according to the invention were made having the formulations noted in Table 1.

TABLE 1

| | Formulation 1 | Formulation 2 | Formulation 3 |
|---|---|---|---|
| | (Parts by | (Parts by | (Parts by |
| Ingredient | weight) | weight) | weight) |
| Midsol Pregel-10* | 96 | 96 | 96 |
| Optimizor CHX H- | 4 | 4 | 4 |
| base** | | | |
| Coloring | 0.03 Chloro- | 0.05 red 40 al | 0.5 caramel |
| | phill KK | Lake 38% | 602 |
| Glycerine | 26 | 26 | 26 |
| Water | 18 | 18 | 18 |

*Gelatinized wheat starch from Midwest Grain Products, Inc.
**Palatability enhancer from Applied Food Biotechnology, Inc.

The above formulations give green, red, and caramel colored samples. The extrusion work was conducted on Wenger TX-85 twin-screw extruder. A powder feed comprising Midsol Pregel-10 was fed to the preconditioner where it was mixed with a liquid feed comprising 26 parts glycerin and 18 parts water. The extrusion conditions are set forth in Table 2 below.

TABLE 2

| | Formulation 1 | Formulation 2 | Formulation 3 |
|---|---|---|---|
| Powder feed rate | 700 | 700 | 700 |
| (lbs/hr) | | | |
| Preconditioner liquid* | 44% | 44% | 44% |
| (% of powder feed) | | | |
| Barrel liquid feed* | 0% | 0% | 0% |
| (% of powder feed) | | | |
| Feed zone temperature | 75 | 75 | 75 |
| (° F.) | | | |
| Zone 1 temperature | 102 | 102 | 102 |
| (° F.) | | | |
| Zone 2 temperature | 106 | 106 | 106 |
| (° F.) | | | |
| Zone 3 temperature | 121 | 121 | 121 |
| (° F.) | | | |
| Zone 4 temperature | 110 | 110 | 110 |
| (° F.) | | | |
| Zone 5 temperature | 116 | 116 | 116 |
| (° F.) | | | |
| Number of profile in- | 4 | 5 | 3 |
| serts (cross-section | (square) | (club shape) | (penta-star) |
| shape) | | | |
| Screw speed (rpm) | 130 | 130 | 130 |

*Liquid solution comprises 26 parts glycerin, 18 parts water

Upon exiting the extruder, the extrudates were conveyed onto a 30 feet long conveying belt with a rotating cutter located at the end of the belt. The cut-off pieces were transferred to a cooler for cooling to room temperature. After coming out of the cooler, the products were ready for packaging. The moisture content in the products varied from 11%-15%. After more than 3 weeks of storage, the treats turned into tough, yet pliable products.

### EXAMPLE 2

A chew time study was performed using dog chews prepared in accordance with Example 1 above. Eighteen (18) dogs, ranging in weights from 19-35 lbs., were used in the study. The dogs were classified as either small (<20 lbs.), medium (25-35 lbs.), or large (40-55 lbs.) and given a treat corresponding to their size. Table 3 gives the product specifications for the dog chews to be fed to each class of dog, i.e. a small treat for a small dog, a medium treat for a medium dog, etc.

TABLE 3

| | | Cross-section | | Cross-section |
|---|---|---|---|---|
| Treat size | Color | shape | Length | area |
| Small (20 g) | red | club-shape | 7.4 cm | 2.43 cm² |
| Medium (35 g) | green | square | 7.6 cm | 3.8 cm² |
| Large (65 g) | caramel | penta-star | 14.5 cm | 3.86 cm² |

All samples were manufactured, packaged, and stored for three weeks prior to testing with the dogs and all had moisture contents of 12.38%. For one week before the formal study began, the dogs were familiarized with the treats. Treats were given to the dogs every other day. Three treats were given to each dog one hour before mealtime. The dogs were monitored by trained technicians who observed the length of time for the dog to consume the treat for up to 30 minutes. Dogs exhibiting chew times of more than 30 minutes and dogs not actively working on the treats were not considered. The results are listed in Table 4.

TABLE 4

| | | | | | Dog wt | Consumption | Percent |
|---|---|---|---|---|---|---|---|
| Dog # | Sex | Breed | Age (yr) | Treat Size | (lbs) | Time | consumed |
| 1 | F | beagle | 3.5 | Green | 37 | 21 | 100% |
| | | | | Green | | Non Consumed | 0% |
| | | | | Green | | 15 | 100% |
| 2 | F | beagle | 1.7 | Green | 28 | 23 | 100% |
| | | | | Green | | 18 | 100% |
| | | | | Green | | 23 | 100% |
| 3 | M | mongrel | 4.9 | Green | 26 | 8 | 100% |
| | | | | Green | | 21 | 100% |
| | | | | Green | | 15 | 100% |
| 4 | F | mongrel | 4.9 | Green | | Non Consumed | 0% |
| | | | | Green | 29 | 12 | 100% |
| | | | | Green | | 29 | 100% |
| | | | | Green | | Non Consumed | 0% |
| 5 | F | mongrel | 4.9 | Green | 33 | 30 | 25% |
| | | | | Green | | Non Consumed | 50% |
| | | | | Green | | Non Consumed | 25% |
| | | | | Green | | Non Consumed | 0% |
| 6 | F | mongrel | 4.9 | Green | 32 | Non Consumed | 0% |
| | | | | Green | | Non Consumed | 0% |
| | | | | Green | | Non Consumed | 25% |
| | | | | Green | | Non Consumed | 25% |
| 7 | F | mongrel | 3.5 | Caramel | 36 | 21 | 100% |
| | | | | Caramel | | 15 | 100% |
| | | | | Caramel | | 12 | 100% |
| 8 | M | mongrel | 3.5 | Green | 28 | 22 | 100% |
| | | | | Green | | 16 | 100% |
| | | | | Green | | 17 | 100% |
| | | | | Green | | Non Consumed | 50% |
| 9 | F | mongrel | 3.4 | Red | 21 | 8 | 100% |
| | | | | Red | | 9 | 100% |
| | | | | Red | | 7 | 100% |
| 10 | M | mongrel | 3.5 | Red | 25 | Non Consumed | 25% |
| | | | | Red | | 29 | 100% |
| | | | | Red | | 27 | 100% |
| | | | | Red | | 17 | 100% |
| 11 | F | mongrel | 3.4 | Green | 36 | Non Consumed | 0% |
| | | | | Green | | 21 | 100% |
| | | | | Green | | 10 | 100% |
| 12 | M | mongrel | 1.5 | Red | 24 | 16 | 100-% |
| | | | | Red | | 13 | 100% |
| | | | | Red | | 15 | 100% |
| 13 | F | beagle | 1.7 | Red | 19 | 14 | 100% |
| | | | | Red | | 25 | 100% |
| | | | | Red | | 8 | 100% |
| 14 | M | mongrel | 1.5 | Green | 31 | 18 | 100% |
| | | | | Green | | 11 | 100% |
| | | | | Green | | 20 | 100% |
| | | | | Green | | 14 | 100% |
| 15 | F | mongrel | 1.5 | Red | 23 | 5 | 100% |
| | | | | Red | | 6 | 100% |
| | | | | Red | | 7 | 100% |
| 16 | F | beagle | 2.4 | Red | 19 | 25 | 100% |
| | | | | Red | | 11 | 100% |
| | | | | Red | | 16 | 100% |
| 17 | F | mongrel | 6.1 | Green | 28 | 7 | 100% |
| | | | | Green | | 10 | 100% |
| | | | | Green | | 6 | 100% |
| 18 | F | beagle | 2.1 | Green | 35 | 21 | 100% |
| | | | | Green | | Non Consumed | 0% |
| | | | | Green | | 25 | 100% |

The gathered data shows that greater than 70% of the chews (not including the chews which were not consumed) were consumed within 10-25 minutes. The long chew times are attributable, at least in part, to the physical cross-linking or retrogradation of the starch.

We claim:

1. An extruded, self-sustaining body comprising between about 50-80% by weight starch, between about 15-23% by weight plasticizer, between about 6-15% by weight water, and less than about 3% by weight fat.

2. The body of claim 1, said starch comprising a quantity of retrograded starch.

3. The body of claim 2, said retrograded starch being selected from the group consisting of gelatinized wheat starch, corn starch, rice starch, tapioca starch, potato starch, and mixtures thereof.

4. The body of claim 1, said plasticizer being selected from the group consisting of glycerin, propylene glycol, and mixtures thereof.

5. The body of claim 4, said plasticizer comprising glycerin.

6. The body of claim 1 further comprising less than about 10% by weight of palatability enhancer.

7. The body of claim 6, said palatability enhancer being selected from the group consisting of liver and liver digest broth concentrate or powder, meat and poultry broth concentrate or spray-dried powder, hydrolyzed proteins, yeast extract, and distillery dry feed.

8. The body of claim 1 further comprising one or more additional ingredients selected from the group consisting of coloring agents, flavoring agents, dental cleaning agents, and breath fresheners.

9. The body of claim 8, said additional ingredients individually comprising less than about 3% by weight of said body.

10. A method of forming an extruded, self-sustaining body comprising the steps of:
providing a mixture comprising between about 50-80% by weight starch, between about 15-23% by weight plasticizer, and between about 6-15% by weight water; and
extruding said mixture to form an extruded body.

11. The method of claim 10 including the step of preconditioning said mixture prior to extrusion thereof.

12. The method of claim 10, said extruding step comprising passing said mixture through a twin-screw extruder.

13. The method of claim 10, said mixture comprising less than about 3% by weight fat.

14. The method of claim 10 including the step of cooling said extruded body.

15. The method of claim 10, said starch comprising a quantity of gelatinized starch.

16. The method of claim 15, said gelatinized starch being selected from the group consisting of gelatinized wheat starch, corn starch, rice starch, tapioca starch, potato starch, and mixtures thereof.

17. The method of claim 10, said plasticizer being selected from the group consisting of glycerin, propylene glycol, and mixtures thereof.

18. The method of claim 17, said plasticizer comprising glycerin.

19. The method of claim 10, said mixture further comprising less than about 10% by weight of palatability enhancer.

20. The mixture of claim 19, said palatability enhancer being selected from the group consisting of meat and poultry broth concentrate or spray-dried powder, liver and liver digest broth concentrate or powder, hydrolyzed proteins, and yeast extract.

21. The method of claim 10, said mixture further comprising one or more additional ingredients selected from the group consisting of coloring agents, flavoring agents, dental cleaning agents, and breath fresheners.

22. The method of claim 21, said additional ingredients individually comprising less than about 3% by weight of said body.

23. The method of claim 10, said mixture having a temperature of less than about 115° C. at the extruder die.

24. A method of forming an extruded, self-sustaining body comprising the steps of:
providing a powder mixture comprising a quantity of pre-gelatinized starch and between about 15-30 parts by weight plasticizer,
said pre-gelatinized starch comprising at least about 90% by weight of said powder mixture;
adding to said mixture between about 10-20 parts by weight water for every 100 parts by weight of powder mixture; and
extruding said mixture to form an extruded body.

25. An extruded, self-sustaining, tough and ductile body comprising between about 50-80% by weight starch, between about 15-23% by weight plasticizer, between about 6-15% by weight water, and less than about 3% by weight fat, said body having a chew time of about 10-25 minutes.

26. The body of claim 25, said body remaining ductile at about 35% relative humidity and above without packaging.
